(19) United States
(12) Patent Application Publication
(10) Pub. No.: US 2016/0154898 A1
(43) Pub. Date: Jun. 2, 2016

(54) TOPIC PRESENTATION METHOD, DEVICE, AND COMPUTER PROGRAM

(71) Applicant: International Business Machines Corporation, Armonk, NY (US)

(72) Inventor: Yuji Sugiyama, Tokyo (JP)

(21) Appl. No.: 14/863,972

(22) Filed: Sep. 24, 2015

(30) Foreign Application Priority Data
Dec. 2, 2014 (JP) 2014-243874

(51) Int. Cl. G06F 17/30

(52) U.S. Cl. CPC G06F 17/30961; G06F 17/3053; G06F 17/30554

(57) ABSTRACT

In an approach to presenting a topic to a user, a computer acquires and records a related person who is connected to the user, and acquires conversation data, wherein the data is at least one of a comment of the user, a comment of each related person who is connected to the user, and a conversation between the related person and the user. The computer extracts a topic from the conversation data, and records the topic. The computer calculates a degree of balance of a topic with a related person, a degree of the user's liking to the related person, a degree of the user's liking to the topic, and a degree of the related person's liking to the topic, and a degree of balance of the topic with the related person is calculated. The computer then presents a topic based on the degree of balance.

### BACKGROUND

The present invention relates to a topic presentation method, and more particularly, to a method of presenting a topic according to the other person, a device, and a computer program.

These days, there are more and more chances of having conversations with a plurality of users through blogs, Facebook™, Twitter™, Internet message boards and the like. In such an environment, there is a demand for presentation of a successful topic according to the other person in the conversation.

As is known in the art, JP2008-539528A by Lunt et al. discloses a technique of calculating compatibility scores of individuals on a social network based on compatibility of interests expressed by the individuals.

As is also known in the art, JP2010-277480A by Kengo et al. discloses a technique of searching for a person who is important to an arbitrary person, based on hobby information indicating the hobby of each person.

Also as is known in the art, JP2010-066814A by Kengo et al. discloses a technique of finding, among people in a specific relationship (for example, a circle of friends), a person who is familiar with a certain topic.

These conventional techniques are techniques for calculating rough relation or compatibility between individuals, and do not present techniques regarding what kind of topic would enable a more successful conversation with the other person.

### SUMMARY

The present invention is for presenting a topic according to the other person. The present invention is for presenting a related person according to the degree of liking. Another object is to present a topic map with respect to the other person. Another object is to present a human map with respect to the other person. Another object is to present a topic according to the degree of balance. Another object is to present a GUI (graphical user interface) with high usability for presenting a topic.

To solve the problem described above, the present invention provides a method of presenting a topic to a user by information processing by a computer including a storage device, the method comprising the steps of acquiring, and recording in a recording device, a related person who is connected to a user, acquiring, on a network, as conversation data, a comment of the user, a comment of each related person who is connected to the user, and a conversation between the related person and the user, extracting a topic from the conversation data, and recording the topic in the storage device, calculating a degree of balance of a topic with a related person, where a related person and a topic are read from the storage device, a value A of a degree of the user's liking to the related person, a value B of a degree of the user's liking to the topic, and a value C of a degree of the related person's liking to the topic are calculated, and a degree of balance V of the topic with the related person is calculated by using the A, the B, and the C, and presenting a topic based on the degree of balance.

Here, in the step of calculating a degree of balance, the degree of balance V is determined by V=A×B×C.

Alternatively, in the step of calculating a degree of balance, the degree of balance V may be determined by V=S×((|A|+|B|+|C|)÷3), where a sign of A×B×C is S (+1 or −1).

Preferably, the step of presenting presents, for each related person, a likable topic or a not very likable topic. Furthermore, the step of presenting presents a topic map according to a degree of balance and having a degree of the user's liking and a degree of the related person's liking as orthogonal axes. Here, the step of presenting may alternatively present a human map according to a degree of balance and having a degree of the user's liking and a degree of the related person's liking as orthogonal axes. Preferably, a step of displaying the related person or the topic in a hierarchical structure is further included.

As another aspect, a computer program for causing a computer to perform each step described above is provided.

Also, a computer-readable recording medium recording the computer program may be provided.

As further another aspect, a device for presenting a topic to a user, wherein each step described above is configured as means by computer hardware, may be provided.

By using the present invention, a topic that enables a successful conversation with the other person may be presented. Also, a GUI for this purpose is provided.

### BRIEF DESCRIPTION OF THE DRAWINGS

FIG. 1 is a flow chart of the present invention, in accordance with an embodiment of the present invention;

FIG. 2 is an example of selection of a person, in accordance with an embodiment of the present invention;

FIG. 3 is example list display of related persons, in accordance with an embodiment of the present invention;

FIG. 4 is example display of a topic map, in accordance with an embodiment of the present invention;

FIG. 5 is example hierarchical display of a list of related persons, in accordance with an embodiment of the present invention;

FIG. 6 is example display of another topic map, in accordance with an alternate embodiment of the present invention;

FIG. 7 is example display of a human map, in accordance with an embodiment of the present invention;

FIG. 8 is example display of hierarchization of a topic list, in accordance with an embodiment of the present invention;

FIG. 9 is example display of calculation results for the degree of balance, in accordance with an embodiment of the present invention;

FIG. 10 is an example application of a topic map, in accordance with an embodiment of the present invention;

FIG. 11 is a diagram for describing a balanced relationship, in accordance with an embodiment of the present invention;

FIG. 12 is a diagram for describing an unbalanced relationship, in accordance with an embodiment of the present invention;

FIG. 13 illustrates an example network battery, in accordance with an embodiment of the present invention;

FIG. 14 illustrates example snowball sampling, in accordance with an embodiment of the present invention;

FIG. 15 is an example hardware configuration of an information processing apparatus, in accordance with an embodiment of the present invention; and

FIG. 16 is a functional block diagram of the present invention, in accordance with an embodiment of the present invention.

### DETAILED DESCRIPTION

Hereinafter, an embodiment of the present invention will be concretely described with reference to the drawings. The embodiment described below is not to limit the invention described in the claims, and it is needless to say that not all of the combinations of the features described in the embodiment are required for the solving means.

Here, the method of the present invention may be realized entirely by hardware, or entirely by software. As is apparent to those skilled in the art, the present invention may be partly implemented as a computer-executable computer program and/or a computer system. Accordingly, in addition to an embodiment as a method, the present invention may be embodied as hardware, as software, and as a combination of software and hardware. The computer program may be embodied as a computer program product recorded in any computer-readable recording medium or storage device such as a hard disk, a DVD, a CD, an optical storage device, or a magnetic storage device. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Hereinafter, the embodiment of the present invention will be described in detail with reference to the drawings. In the following, description is given on a user interface, of a display device of a personal computer or the like, that uses a pointing device or the like, but the same thing can be said for operation on a touch display of a smartphone or the like by a finger.

### 1.0 Hardware Configuration

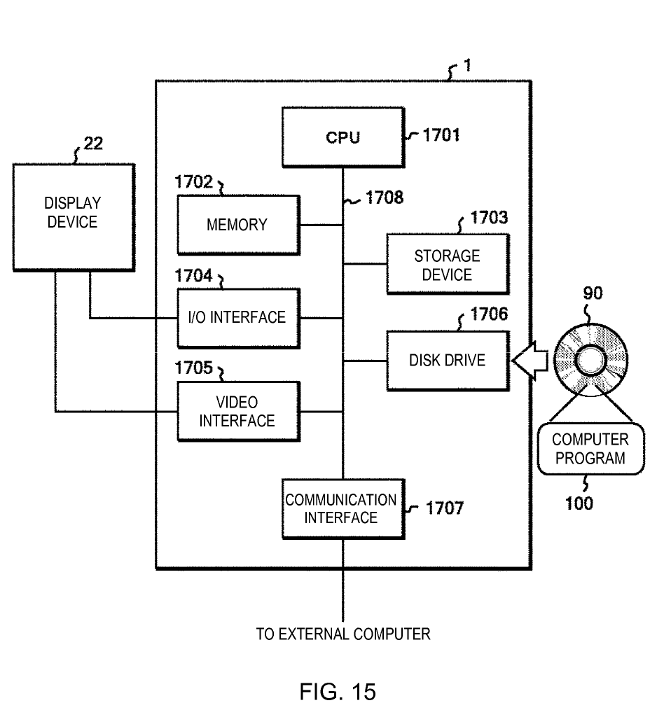

FIG. 15 is a block diagram illustrating the configuration of an information processing apparatus according to an embodiment of the present invention. An information processing apparatus 1 of the present invention is configured at least from a CPU (central processing unit) 1701, a memory 1702, a storage device 1703, an I/O interface 1704, a video interface 1705, a disk drive 1706, a communication interface 1707, and an internal bus 1708 connecting the above-described pieces of hardware.

The CPU 1701 is connected to each of the above-described pieces of hardware of the information processing apparatus 1 via the internal bus 1708, and controls the operation of each of the pieces of hardware, and also executes various software functions according to a computer program 100 stored in the storage device 1703. A load module is loaded into the memory 1702 at the time of execution of the computer program 100, and temporary data and the like generated at the time of execution of the computer program 100 are stored therein.

The storage device 1703 is a built-in fixed storage device, and is configured from a ROM or the like. The computer program 100 stored in the storage device 1703 is downloaded by the portable disk drive 1706 from a portable recording medium 90, such as a DVD or a CD-ROM, recording information such as programs and data, and is, at the time of execution, loaded from the storage device 1703 into the memory 1702 to be executed. In other embodiments, a computer program downloaded from an external computer that is connected via the communication interface 1707 may also be used.

The communication interface 1707 is connected to the internal bus 1708, and is capable of performing data exchange with an external computer or the like by being connected to an external network such as the Internet, LAN, WAN or the like.

The I/O interface 1704 receives input of data from external components. For example, in the case a touch panel is mounted on a display device 22, signals from the touch panel are received via the I/O interface 1704. Furthermore, the video interface 1705 is connected to the display device 22. A user interface, described in the embodiment, for presenting a topic according to the other person is displayed on the display device 22.

### 2.0 Functional Block

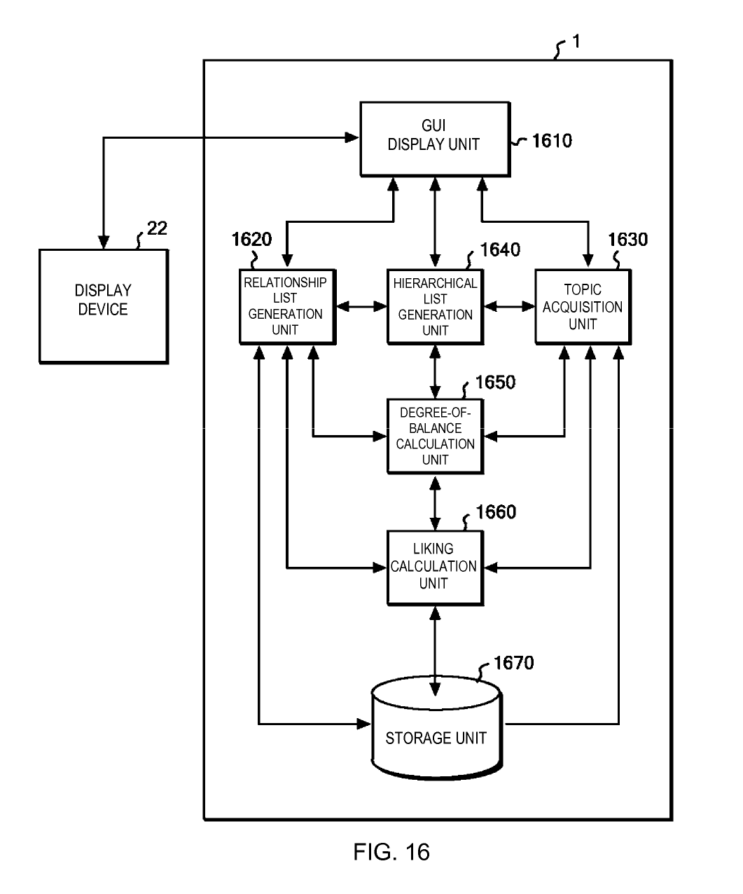

FIG. 16 illustrates a functional block diagram of the present invention. A related person list is created by a relationship list generation unit 1620 for a person A specified on a GUI display unit 1610, based on human relationships on the Internet and static human relationships data that are recorded in a storage unit 1670. Also, at this time, a liking calculation unit 1660 calculates, and adds to the relationship list, the degree of mutual liking with a related person based on conversation data acquired from the Internet and recorded in the storage unit 1670.

Furthermore, when a specific person B is selected on the GUI display unit 1610 from the related person list, a topic acquisition unit 1630 extracts into a list topics associated with the person A and the person B from conversation data recorded in the storage unit 1670. At this time, the liking calculation unit 1660 calculates the degrees of liking to the topics based on the conversation data, and adds the information to the topic list.

When the “degree of person A's liking to B”, the “degree of person A's liking to a topic”, and the “degree of person B's liking to the topic” are determined, a degree-of-balance calculation unit 1650 calculates the degree of balance by an existing calculation formula based on these degrees of liking, and adds the degree of balance to the topic list. The final topic list is transmitted to the GUI display unit, and a topic map is displayed on the display device.

The device of the present invention performs presentation of topics for specified persons, but in the flow chart below, for the sake of convenience, a method of presenting a topic for a person related to a user will be described with reference to the drawing.

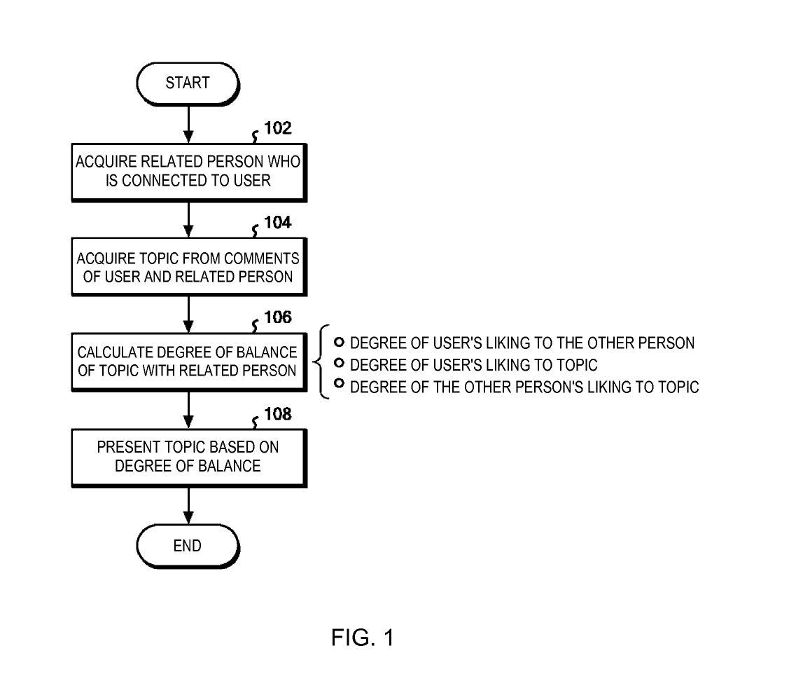

FIG. 1 is a flow chart of the method of the present invention. In step 102, the method of the invention acquires a related person who is connected to a user. The related person is acquired based on the conversation or comments on the Internet, such as messages on a blog, Facebook, Twitter, message boards and the like.

Also, the related person may be acquired as known static information from a family relationship, a circle of friends, or work-related people. In the following, the related person may alternatively be referred to as the other person.

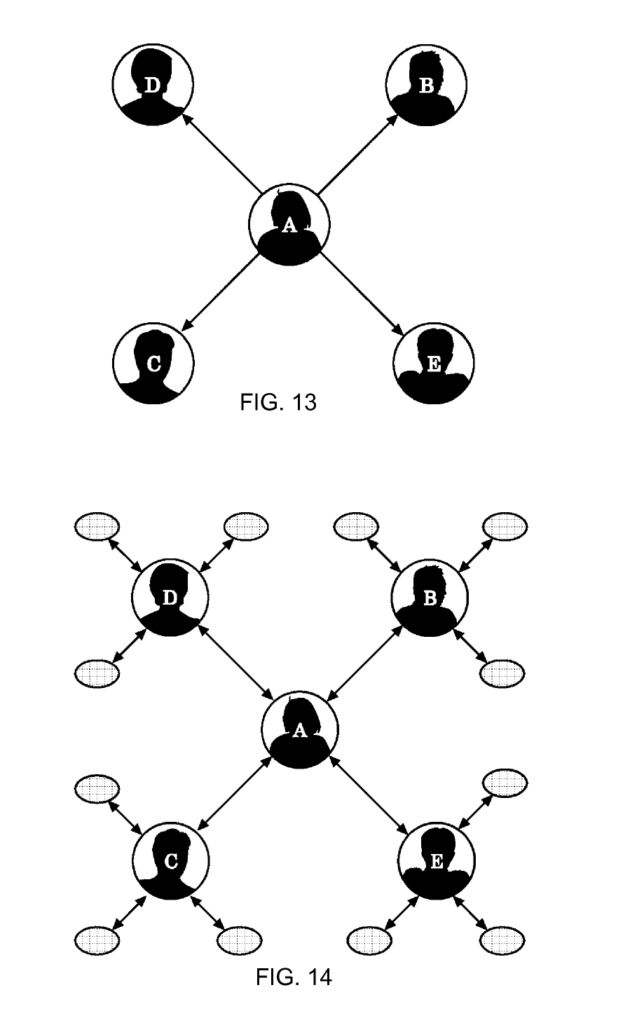

A technique of conducting a research on the human relationships, in various embodiments, will be described with reference to FIGS. 13 and 14. First, the human relationships on a network are basically a network battery. An example of the network battery is illustrated in FIG. 13. The network battery is a technique developed to conduct a census on human relationships in the United States of America applied to perform research on human relationships on an SNS. FIG. 13 illustrates which account is followed by an Account A on Twitter, for example.

Next, a technique of conducting research on human relationships over a wide range is depicted, as a method called snowball sampling. An example of the snowball sampling is illustrated in FIG. 14. The snowball sampling is a method of analyzing wide-range human relationships by extending the network battery in a snowballing manner.

In the example in FIG. 14, related persons are acquired for the account A on Twitter by applying the network battery, and then, a research is conducted on the accounts of the related persons in the same manner, for example. It is thereby possible to find out the type of people the account A is connected to. The method described above is only an example, but related persons of a user on the Internet may be acquired in this manner.

Next, in step 104, the method of the invention acquires a topic from the comments of the user and a related person. Here, the topic is acquired from the subjects, verbs, objects, nouns, gerunds, and the like present in the texts of conversation with the other person. In embodiments, the method of the invention performs natural language analysis and speech parts analysis on the texts of conversation to acquire the topic, or more simply, by acquiring all the words obtained by morphological analysis as topics. It should be noted here that a person may also be a topic.

Next, the method of the invention calculates the degree of balance of a topic with the related person in step 106. This step is the central step of the method of the present invention. Broadly speaking, the degree of the user's liking to the other person, the degree of the user's liking to a topic, and the degree of the other person's liking to the topic are calculated.

There are many existing techniques for calculating, based on a given text, the degree of liking indicating who likes what. The simplest method is to determine based on whether a predetermined word appears in a text. For example, if keywords that are registered in a dictionary in advance, such as “fun”, “exciting”, “like”, and “interested”, are present in a text, the subject has a liking for the object.

On the other hand, in the case of a negative keyword, the degree of liking is negative. The degree of liking is finely adjusted according to the number of appearances, the degree of emphasis and the like of the keyword. More specifically, the degree of liking may be precisely calculated by parsing the entire text. There are various other methods of calculating the degree of liking.

Normally, the “degree of the user's liking to the other person”, the “degree of the user's liking to a topic”, and the “degree of the other person's liking to the topic” are calculated from a plurality of sentences (texts), but a plurality of degrees of liking may sometimes be calculated from one sentence.

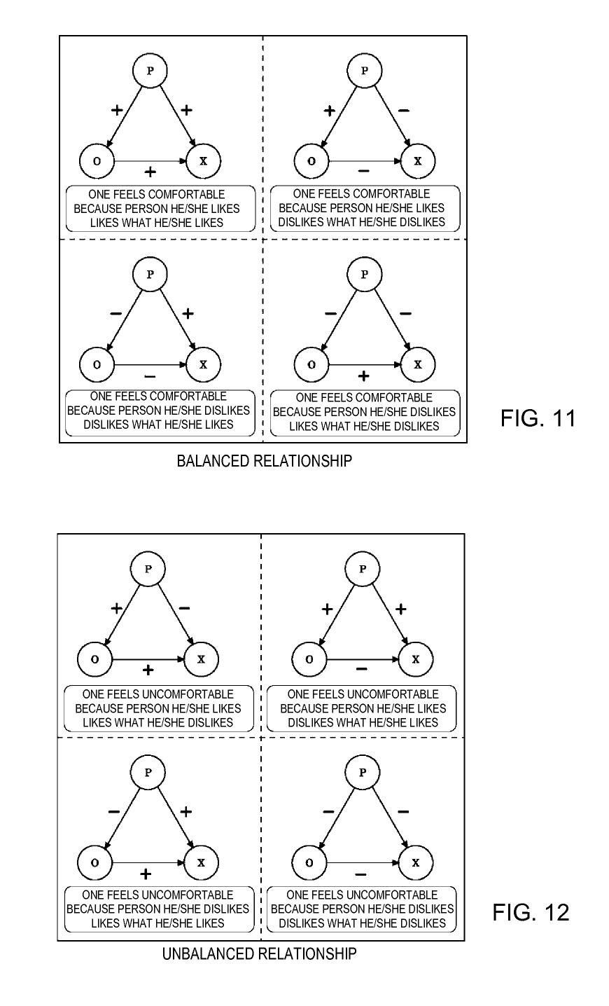

Then, in step 108, the method of the invention presents a topic that would be successful with the other person to the user based on each degree of balance. Preferably, the degree of balance is calculated by using Heider's balance theory. Heider's balance theory is described below with reference to FIGS. 11 and 12.

Simply put, the balance theory is a theory for measuring the psychological balance based on the difference in the liking from another person. In FIGS. 11 and 12, “P” represents oneself, “O” represents another person (the other person), and “X” represents an object (topic).

FIG. 11 illustrates a balanced relationship. FIG. 11 illustrates four patterns. The bottom left example means that one feels comfortable (balanced) because a person he/she dislikes dislikes what he/she likes.

According to this balance theory, one's liking to another person, one's liking to a certain object, and the other person's liking to the object are expressed by (+) and (−) and are multiplied together, and if balance is achieved, (+) is obtained, and if balance is not achieved, (−) is obtained. The bottom left example in FIG. 11 is (+)×(−)×(−)=(+), and balance is achieved.

FIG. 12 illustrates an unbalanced relationship. FIG. 12 illustrates four patterns. The bottom left example means that one feels uncomfortable (unbalanced) because a person he/she dislikes also likes what he/she likes. That is, the bottom left example in FIG. 12 is (+)×(−)×(+)=(−), and balance is not achieved.

In this manner, the balance theory analyses the psychological balance between oneself and another person by analyzing what impressions are had in the relationship of oneself, another person (or the other person), and an object (or a topic).

The calculation formula for the degree of balance according to the present invention is given below as Equation 1. When the “degree of a user's liking to the other person” is given as A, the “degree of the user's liking to a topic” is given as B, and the “degree of other person's liking to the topic” is given as C, the simplest calculation formula for determining the degree of whole balance (V) is as follows. It should be noted that A, B, and C are rational numbers having signs, and thus V is also a rational number having a sign.

V=A×B×C Equation 1

Or, in the case of comparing the degree of balance with another system, normalization is needed, and a cubic root of V given above may be calculated and be taken as the degree of balance.

Another calculation formula for the degree of balance is given below as Equation 2. When, as in the case described above, the “degree of a user's liking to the other person” is given as A, the “degree of the user's liking to a topic” is given as B, and the “degree of the other person's liking to the topic” is given as C, the degree of balance V of an average value is determined by the following formula.

V=S×((|A|+|B|+|C|)÷3) Equation 2

The S here is for calculating the sign and is the sign for A×B×C, and takes the value of +1 or −1. Also, in the case where there is the degree of liking that takes the value of 0, this value is not used in the sign calculation.

FIG. 9 illustrates an example 900 where the degrees of balance (the average values) are calculated based on the degrees of liking to the other persons and topics. In FIG. 9, the degree of the user's liking to a person F is +100, the degree of the user's liking to a topic is +10, and the degree of the person F's liking to the topic is −20, and thus the degree of balance V determined is as below, using Equation 2 from above.

V=−1×((100+10−20)/3)=−30 Equation 2 Example

Then, in step 108, the degree of balance with a related person for a topic is calculated, and is presented to the user. It is possible to have a topic with a higher degree of balance presented to the user as a topic that would be successful with the other person.

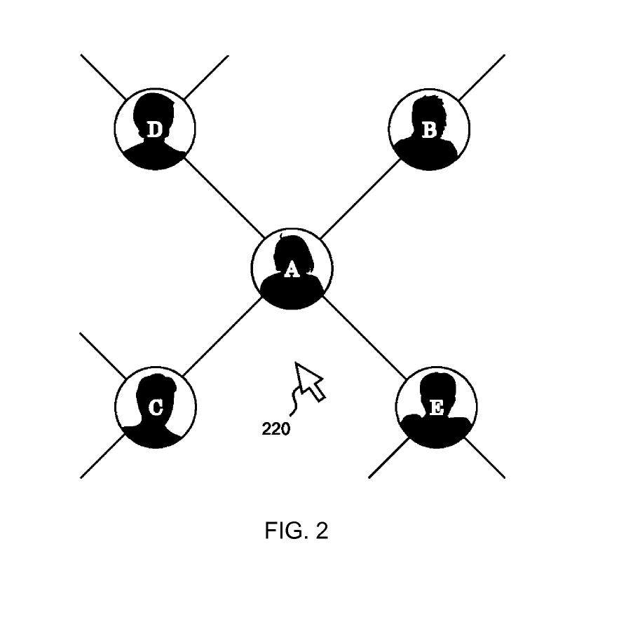

FIG. 2 illustrates related persons of a user A on the display device 22 of the information processing apparatus 1 according to the embodiment of the present invention. The related persons are acquired by using the method of snowball sampling or the like and are recorded in the memory 12, and are displayed on the display device 22.

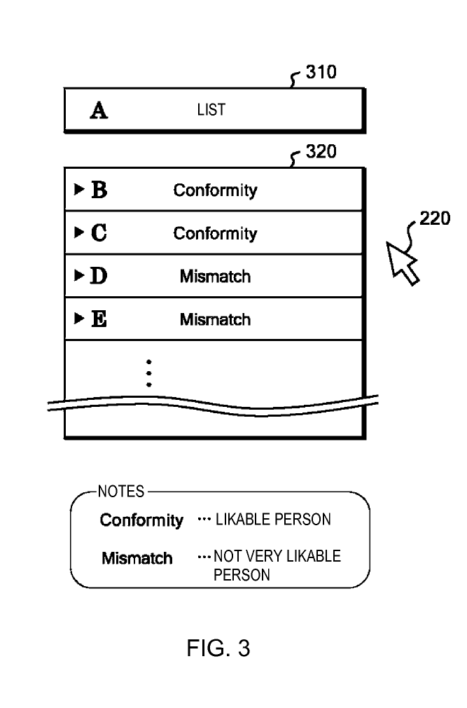

Now, when the user A is selected by a pointer 220, persons connected to the user A are displayed on the display device 22 as a list, as illustrated in FIG. 3. The user interfaces of FIGS. 2 and 3 are only examples, and the list in FIG. 3 may alternatively be displayed by directly inputting the user A by a keyboard or the like.

It is indicated by 310 in FIG. 3 that it is information about persons related to the user A. Also, a list of related persons (in the example illustrated, B, C, D, and E) is displayed by 320. A specific person is then selected by the pointer 220. Additionally, in FIG. 3, “Conformity” indicates a likable person, and “Mismatch” indicates a not very likable person.

Next, when a likable person B is selected by the pointer 220 in FIG. 3, a topic map for the users A and B is displayed. The topic map is a map displaying which topic achieves balance or does not achieve balance for conversation between the users A and B.

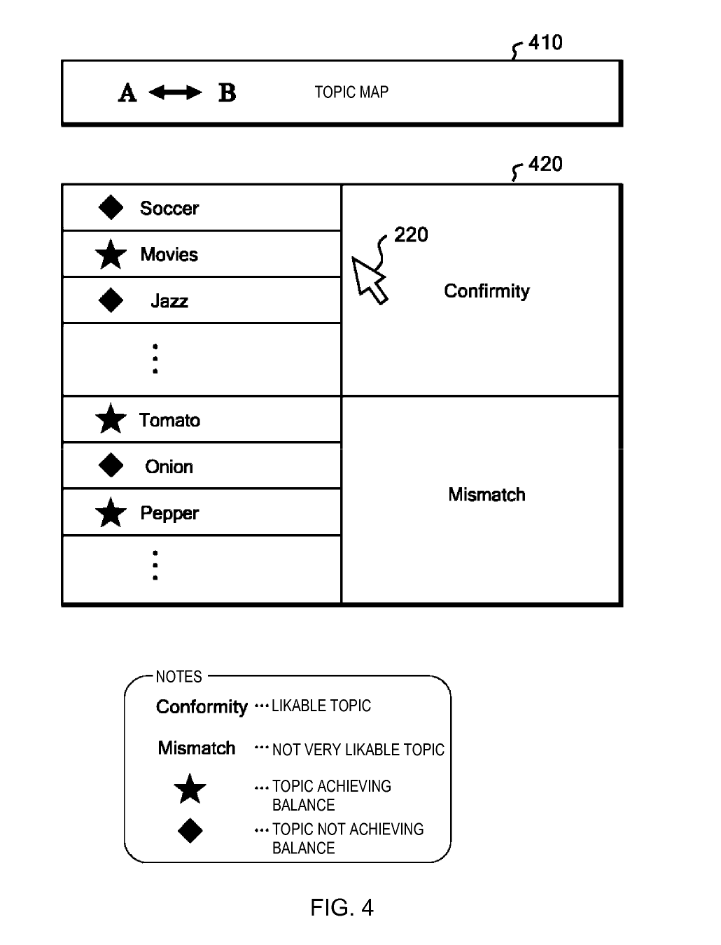

FIG. 4 illustrates an example display of the topic map for A and B. It is indicated by 410 in FIG. 4 that it is the topic map for the users A and B. Also, topics taking into account the degrees of balance between the users A and B are displayed by 420. “Conformity” and “Mismatch” on the right side of 420 are the degrees of liking to the topics from the side of B.

What are to be noted in FIG. 4 are the star marks and the diamond marks. In embodiments, these marks are added based on the degrees of balance calculated. The star mark is added to a topic that achieves balance between A and B, and the diamond mark is added to a topic that does not achieve balance. The values of the degrees of balance may also be displayed together with these marks.

As can be understood from FIG. 4, the present invention is capable of presenting a successful topic also with regard to a topic that is not very likable to the user B. For example, a topic regarding Tomato is not very likable to B, but makes a topic that achieves balance for conversation with the user A.

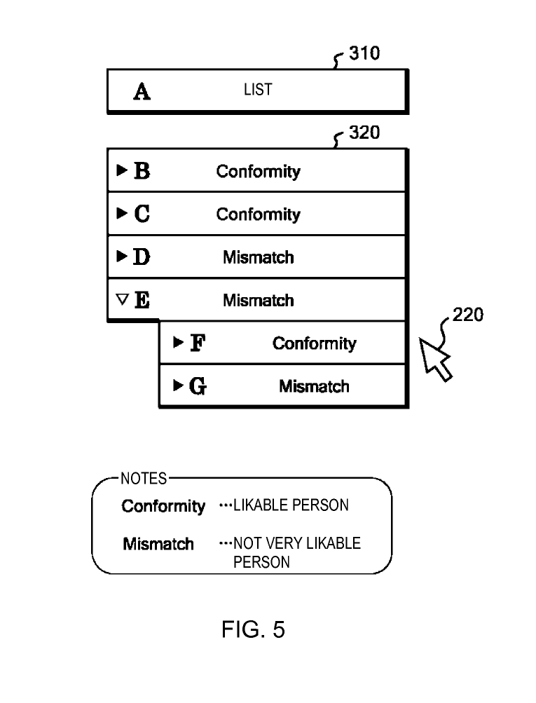

FIG. 5 is an example of a display of information about persons related to the user A in a wider range. When the triangle mark at E in FIG. 3 is pressed, a person related to E is retrieved, and the degree of liking between A is added and displayed on its side. Hierarchization of human relationships and selection are thus enabled.

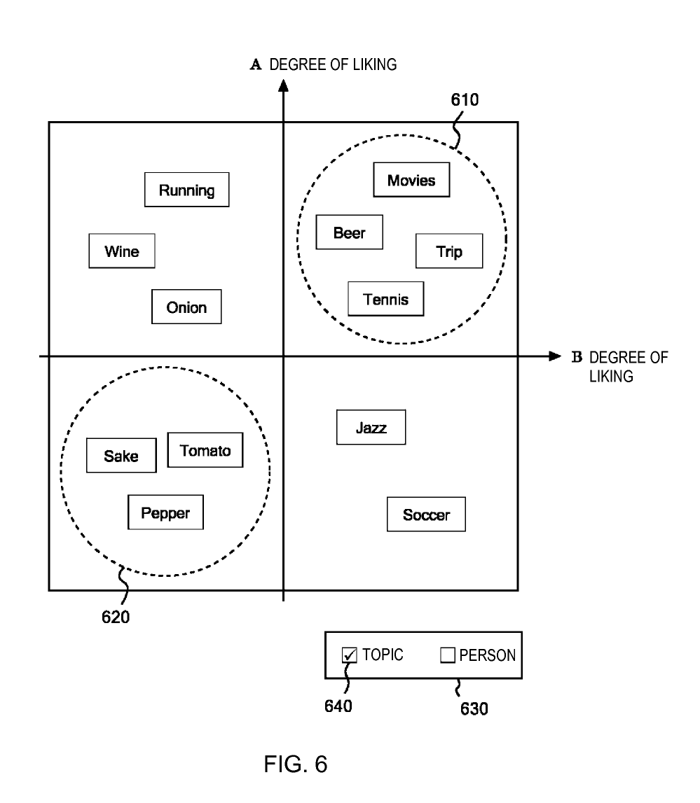

FIG. 6 is example display of another topic map, in accordance with an alternate embodiment of the present invention. When a likable person B is selected by the pointer 220 in FIG. 3, a two-dimensional topic map having the degree of liking of A as the y-axis and the degree of liking of B as the x-axis is displayed, as illustrated in FIG. 6.

FIG. 6 is example display of a two-dimensional map, but a map of three or more dimensions may also be adopted as long as the degree of liking of A and the degree of liking of B are given as orthogonal axes.

In FIG. 6, a first quadrant 610 and a third quadrant 620 indicate topics that achieve balance between the users A and B. In contrast, second and fourth quadrants indicate topics that do not achieve balance.

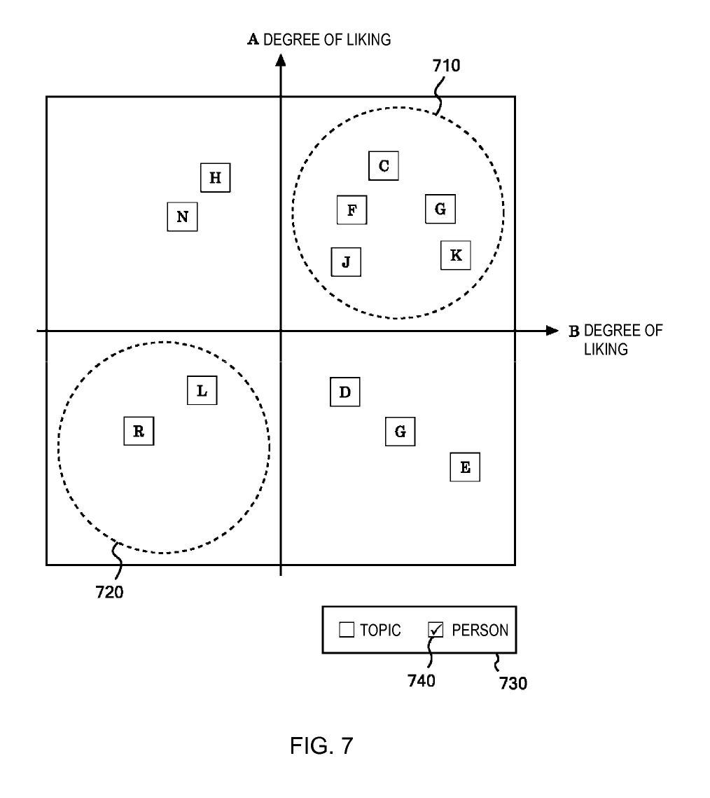

A panel 630 in FIG. 6 is an option panel for changing display between topics and persons, in embodiments of the present invention. Here, a checkbox for “topics” is selected in the option panel 630, but when a checkbox for persons is selected, display as illustrated in FIG. 7 is performed.

FIG. 7 is example display of a human map by which persons who achieve balance and persons who do not achieve balance for the users A and B may be grasped at a glance.

In FIG. 7, a first quadrant 710 and a third quadrant 720 are groups of persons who achieve balance for the users A and B. In contrast, it can be seen that a second quadrant and a fourth quadrant are groups of persons who do not achieve balance. Using this enables to find a person who achieves balance from a wide range of human relationships. Alternatively, it is also possible to detect an unknown person who does not achieve balance.

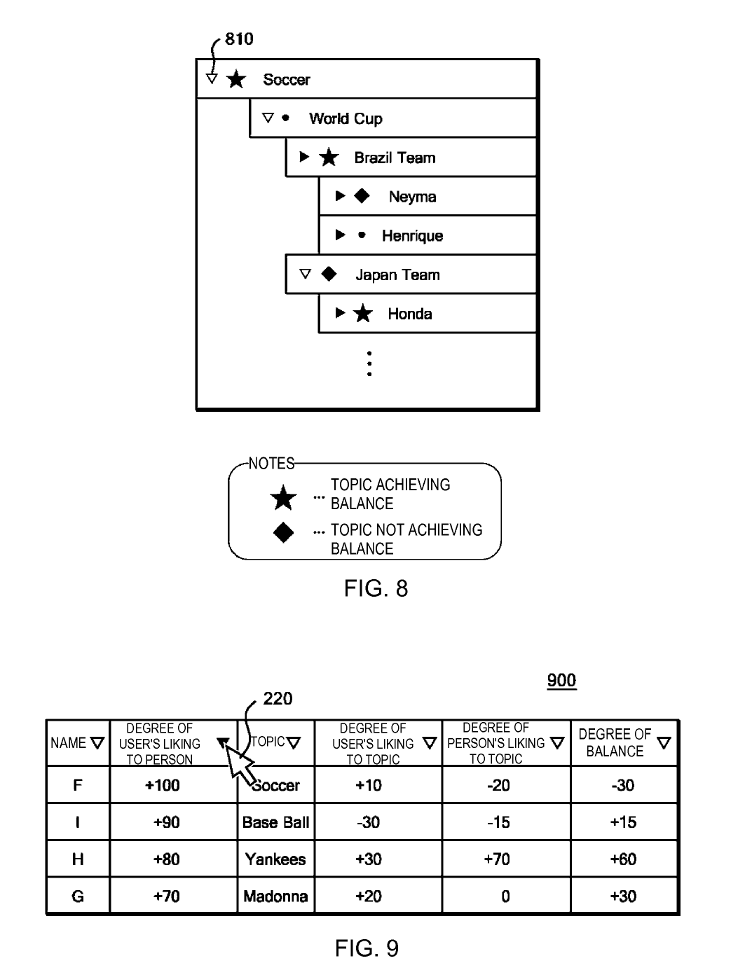

FIG. 8 is example display of a hierarchization of topics. “Soccer” in FIG. 4 is a topic that does not achieve balance between the users A and B, but when “Soccer” is expanded in FIG. 4, it is hierarchized and displayed as illustrated in FIG. 8, and includes topics that achieve balance. When “World Cup” is expanded in FIG. 8, it can be seen that “Brazil Team” is a topic that achieves balance. In this manner, by hierarchizing a topic, it is possible to provide a very precise topic map.

FIG. 9 illustrates, as an example, calculation results for related persons and the degrees of balance of topics in the form of a table. The data structure in the memory has the same table structure as in FIG. 9, and is held in the form of an array. In the example in FIG. 9, the degree of a user's liking to a person, the degree of the user's liking to a topic, the degree of the person's liking to the topic, and lastly, the degree of balance of a topic with respect to each person are illustrated.

The number of topics for a person is one in FIG. 9, but normally, there are a plurality of topics. Items may be sorted by using the pointer 220. FIG. 9 is an example where sorting is performed based on the degree of the user's liking to a person.

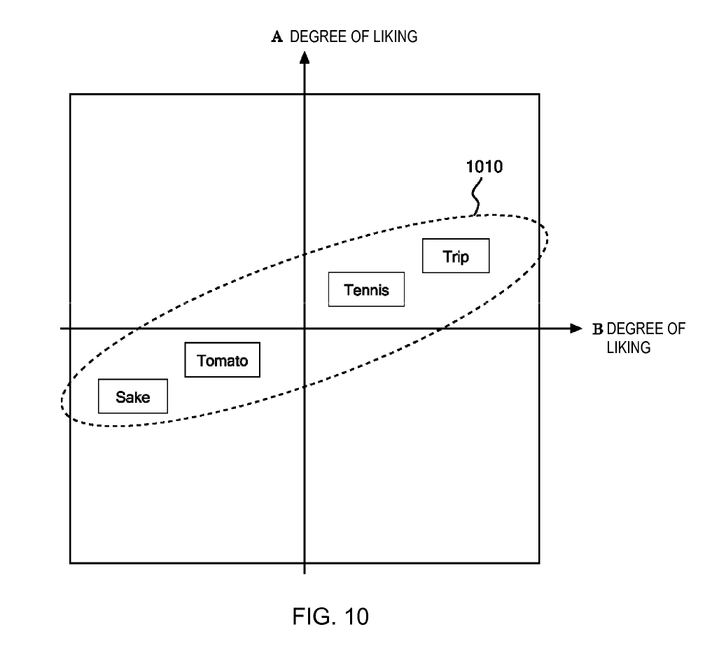

FIG. 10 illustrates an example application of the topic map, in accordance with an embodiment of the present invention. In FIG. 10, a topic bias for the users A and B is expressed by a straight line or an ellipse. This inclination of the diagram may be easily obtained by using linear regression analysis or the like. The bias of the degree of balance for the users A and B may thus be determined Basically, if the ellipse is positively tilted, the degree of balance is high on the whole. Also, the degree of balance may be said to be higher as it is closer to the straight line y=x.

Many example applications are conceivable with respect to the present invention without departing from its essence. For example, a real-time topic map may be provided by dynamically acquiring conversation data over the network from the communication interface 1707. Also, since the human relationships are updated in real time, dynamic discovery of a new related person is enabled.

Moreover, the present invention describes the method of calculating the degree of balance of a topic and one-on-one human relationships, and presentation thereof, but the degree of balance may also be calculated for a group. For example, an active group in a society is called a MOB, and application to calculation of the degree of balance for the MOB and a topic is also possible.

Additionally, the present invention is not limited to the embodiment described above, and various changes, modifications, and the like are possible within the scope of the present invention.

1. A method for presenting a topic to a user by a computer including a storage device, the method comprising the steps of:
acquiring, by the computer, and recording, by the computer, in a recording device, a related person who is connected to a user;
acquiring, by the computer via a network, conversation data, wherein conversation data includes at least one of a comment of the user, a comment of each related person who is connected to the user, or a conversation between the related person and the user;
extracting, by the computer, a topic from the conversation data;
recording, by the computer, the topic in the storage device;
calculating, by the computer, a degree of balance of a topic with a related person, where a related person and a topic are read from the storage device, a value A of a degree of the user's liking to the related person, a value B of a degree of the user's liking to the topic, and a value C of a degree of the related person's liking to the topic, and wherein a degree of balance V of the topic with the related person is calculated by using the A, the B, and the C; and
presenting, by the computer, a topic based on the degree of balance.

2. The method according to claim 1, wherein, in the step of calculating a degree of balance, the degree of balance V is determined by
V=A×B×C.

3. The method according to claim 1, wherein, in the step of calculating a degree of balance, the degree of balance V is determined by
V=S×((|A|+|B|+|C|)÷3),
where a sign of A×B×C is S (+1 or −1).

4. The method according to claim 1, wherein the step of presenting is a step of presenting, by the computer, for each related person, a likable topic or a not very likable topic.

5. The method according to claim 1, wherein, in the step of presenting includes presenting, by the computer, a topic map according to a degree of balance and having a degree of the user's liking and a degree of the related person's liking as orthogonal axes.

6. The method according to claim 1, wherein, in the step of presenting includes presenting, by the computer, a human map according to a degree of balance and having a degree of the user's liking and a degree of the related person's liking as orthogonal axes.

7. The method according to claim 1, further comprising a step of displaying, by the computer, the related person or the topic in a hierarchical structure.

8. A computer program product for presenting a topic to a user, the computer program product comprising:
one or more computer readable storage devices and program instructions stored on the one or more computer readable storage devices, the stored program instructions comprising:
program instructions to acquire and to record a related person who is connected to a user;
program instructions to acquire conversation data, wherein conversation data includes at least one of a comment of the user, a comment of each related person who is connected to the user, or a conversation between the related person and the user;
program instructions to extract a topic from the conversation data;
program instructions to record the topic in the storage device;
program instructions to calculate a degree of balance of a topic with a related person, where a related person and a topic are read from the storage device, a value A of a degree of the user's liking to the related person, a value B of a degree of the user's liking to the topic, and a value C of a degree of the related person's liking to the topic, and wherein a degree of balance V of the topic with the related person is calculated by using the A, the B, and the C; and
program instructions to present a topic based on the degree of balance.

9. The computer program product according to claim 8, wherein, in the program instructions to calculate a degree of balance, the degree of balance V is determined by
V=A×B×C.

10. The computer program product according to claim 8, wherein, in the program instructions to calculate a degree of balance, the degree of balance V is determined by
V=S×((|A|+|B|+|C|)÷3),
where a sign of A×B×C is S (+1 or −1).

11. The computer program product according to claim 8, wherein the program instructions to present include program instructions to present, for each related person, a likable topic or a not very likable topic.

12. The computer program product according to claim 8, wherein the program instructions to present include program instructions to present a topic map according to a degree of balance and having a degree of the user's liking and a degree of the related person's liking as orthogonal axes.

13. The computer program product according to claim 8, wherein the program instructions to present include program instructions to present a human map according to a degree of balance and having a degree of the user's liking and a degree of the related person's liking as orthogonal axes.

14. The computer program product according to claim 8, further comprising program instructions to display the related person or the topic in a hierarchical structure.

15. A computer system for presenting a topic to a user, the computer system comprising:
one or more computer processors;
one or more computer readable storage devices;
program instructions stored on the one or more computer readable storage devices for execution by at least one of the one or more computer processors, the stored program instructions comprising:
program instructions to acquire and to record a related person who is connected to a user;
program instructions to acquire conversation data, wherein conversation data includes at least one of a comment of the user, a comment of each related person who is connected to the user, or a conversation between the related person and the user;
program instructions to extract a topic from the conversation data;
program instructions to record the topic in the storage device;
program instructions to calculate a degree of balance of a topic with a related person, where a related person and a topic are read from the storage device, a value A of a degree of the user's liking to the related person, a value B of a degree of the user's liking to the topic, and a value C of a degree of the related person's liking to the topic, and wherein a degree of balance V of the topic with the related person is calculated by using the A, the B, and the C; and
program instructions to present a topic based on the degree of balance.

16. The computer system according to claim 15, wherein, in the program instructions to calculate a degree of balance, the degree of balance V is determined by
V=S×((|A|+|B|+|C|)÷3),
where a sign of A×B×C is S (+1 or −1).

17. The computer system according to claim 15, wherein the program instructions to present include program instructions to present, for each related person, a likable topic or a not very likable topic.

18. The computer system according to claim 15, wherein the program instructions to present include program instructions to present a topic map according to a degree of balance and having a degree of the user's liking and a degree of the related person's liking as orthogonal axes.

19. The computer system according to claim 15, wherein the program instructions to present include program instructions to present a human map according to a degree of balance and having a degree of the user's liking and a degree of the related person's liking as orthogonal axes.

20. The computer system according to claim 15, further comprising program instructions to display the related person or the topic in a hierarchical structure.
